(19) United States
(12) Patent Application Publication
(10) Pub. No.: US 2019/0376314 A1
(43) Pub. Date: Dec. 12, 2019

(54) DOOR STRIKER FOR PREVENTING DOOR MOVEMENT

(71) Applicant: Sung Myon SONG, Sejong (KR)

(72) Inventor: Sung Myon SONG, Sejong (KR)

(21) Appl. No.: 16/487,068

(22) PCT Filed: Feb. 8, 2018
(86) PCT No.: PCT/KR2018/001683

§ 371 Date: Aug. 19, 2019

(30) Foreign Application Priority Data
Feb. 20, 2017 (KR) 20-2017-0000837

(51) Int. Cl. E05B 15/02; E05B 17/00

(52) U.S. Cl. CPC E05B 15/0205; E05B 63/08; E05B 17/0045

(57) ABSTRACT

A door striker has an improved cross-sectional shape so that a latch can be maintained in close contact with the striker without back-and-forth clearance. In contrast, with conventional strikers, a door may make noise by being shaken due to application of external forces including changes in indoor and outdoor air pressure. Door strikers described herein include a latch assembly on a side surface of a door, which is connected to and operated by a handle member. A striker, to which a latch of the latch assembly is fitted, is installed on a door frame. The striker has a front latching protrusion for latching a front surface of the latch and a rear latching protrusion for latching a rear surface of the latch. The front latching protrusion has a right-angled surface of a front end thereof and an inclined surface the inside thereof.

### TECHNICAL FIELD

The present invention relates to a door striker, more particularly, a door striker with improvement in a cross-sectional shape in order to solve such a problem of the existing striker that a door is shaken and makes noise due to application of various external forces including a change between indoor and outdoor air pressures in a state wherein a latch mounted on the door is caught by the door striker mounted on a door frame, comprising a configuration in which a latch can be maintained in close contact with the striker while the latch is fitted to the striker without back-and-forth clearance.

### BACKGROUND ART

In general, a room door or entrance door has a lock function to be held in a closed position and to ensure security or privacy, in particular, is provided with a handle member exposed back and forth, and a latch assembly (also referred to as ‘latch bolt’ or ‘mortise lock’) as a locking mechanism is provided on a lateral surface of the door and operatively connected to the handle member.

Further, a door frame is provided with a striker to which a latch of the latch assembly is fitted and engaged in a door frame, wherein the striker is usually made of various materials by different methods, such as press working with a metal sheet, casting or injection molding of synthetic resin, etc.

Meanwhile, as shown in FIG. 1, with regard to a conventional door striker, a width D in the front and rear sides of the striker 1 is wider than a thickness d of the latch 2, when the latch of the latch assembly is inserted therein and engaged therewith. Therefore, if a change between indoor and outdoor air pressures occurs or wind blows, the door 3 may rattle back and forth, whereby the latch 2 bumps the front and rear ends of the striker 1 and makes a noise. This interrupts sleep and causes anxiety, and also has been a main factor causing loss of consumer confidence in product quality and completeness of the door.

Conventional art related to the present invention includes, for example, a striker assembly with a variable bolt insertion part disclosed in Patent Document 1, wherein the bolt insertion part, in which a teddy bolt and a latch bolt are inserted, is scale-adjustable to thus prevent loosening or shaking of the door. However, this assembly has disadvantages that a structure is complex and requires additional components such as a throttle, an adjustment bolt and a stopper, and these components must be reset frequently.

Further, Patent Document 2 discloses a striker for a push-pull type door locking device, which has a lower bent surface bent by about 70 to 80° so as to be in continuous contact with a latch bolt as far as the latch bolt is protruded from a mortise lock, thereby preventing movement of the door. However, this striker has a problem that, when pushing or pulling out the door in a single direction, the latch bolt slides along the inclined lower bent surface and may cause a situation that the door is apt to be opened.

Further, a rattling-proof door lock striker assembly disclosed in Patent Document 3 was proposed for fixing the striker to an optimized site despite of repeated impact, with a configuration wherein, when a striker is combined with a striker housing, a screw coupling position in a hole (slit) of the striker could be adjusted in accordance with a position of a protrusion in the striker housing. However, with respect to the above configuration, the striker needs an alternative housing to raise unit costs, in addition, the coupling position may be altered due to repeated door impact which in turn entails deterioration in effects of preventing movement of the striker.

### PRIOR ART DOCUMENT

### Patent Document

(Patent Document 1) Korean Patent Registration No. 10-1441363 (registered on Sep. 11, 2014)

(Patent Document 2) Korean Utility Model Laid-Open Publication No. 20-2014-0002186 (laid-open on Apr. 17, 2014)

(Patent Document 3) Korean Patent Laid-Open Publication No. 10-2017-0009020 (laid-open on Jan. 25, 2017)

### DISCLOSURE

### Technical Problem

The present invention has been proposed to overcome the aforementioned problems, and an object of the present invention is to provide a door striker with improvement in a cross-sectional shape in order to solve such a problem of the existing striker that a door shakes and makes noise due to application of various external forces including a change between indoor and outdoor air pressures in a state wherein a latch mounted on the door is caught by the door striker mounted on a door frame, which includes a configuration in which the latch can be maintained in close contact with the striker while the latch is fitted to the striker without back-and-forth clearance.

### Technical Solution

In order to solve the above problems, the present invention provides a door striker for preventing movement (or rattling) of a door, with configurations of: a latch assembly that is mounted on a lateral surface of a door and operatively connected to a handle member; and a striker mounted on a door frame, to which a latch in the latch assembly is fitted and engaged, wherein the striker includes a front sill for latching a front surface of the latch and a rear sill for latching a rear surface of the latch wherein the front sill is composed of a right-angled surface at a front end and an inner inclined surface so that, when inserting the latch, an end of the front surface of the latch contacts the inclined surface via an elastic member in the latch assembly while keeping the rear surface of the latch in contact with the rear sill, and wherein, even when the door is pushed to one side by external force and the end of the front surface of the latch slides along the inclined surface, the latch is caught by the right-angled surface at the front end to thus prevent the door from being opened.

### Advantageous Effects

As described above, according to the present invention, the front and rear surfaces of the latch are in contact with the front and rear sills so as to prevent the door from rattling or shaking due to wind or the like, thereby not causing noise. Further, when wind blows strongly or even when the door is pulled by external force, the front surface of the latch is caught by the right-angled surface formed on the front sill in the striker to thus prevent the door from being opened, thereby ensuring protection of privacy. Accordingly, the present invention may achieve effects of maintaining quietness of a door and ensuring substantially improved quality of the same.

### DESCRIPTION OF DRAWINGS

FIG. 1 is a plan cross-sectional view illustrating a conventional door striker with a latch engaged therewith.

FIG. 2 is a plane cross-sectional view illustrating a door striker with a latch engaged therewith, according to one embodiment of the present invention.

FIG. 3 is a plan cross-sectional view illustrating the door shown in FIG. 2, which is pulled by external force.

FIG. 4 is a perspective view illustrating a door striker according to another embodiment of the present invention.

FIG. 5 is a cross-sectional view taken along line A-A shown in FIG. 4.

### BEST MODE

Hereinafter, preferred embodiments of the present invention without limitation thereto will be described in detail with reference to the accompanying drawings.

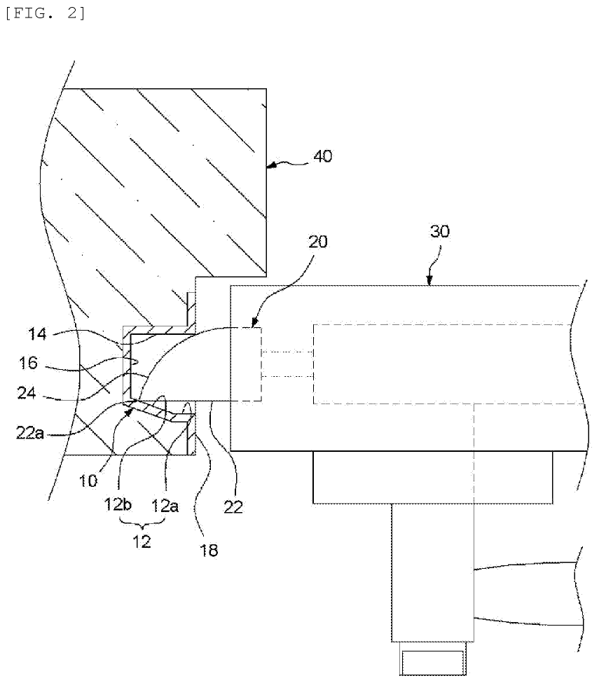

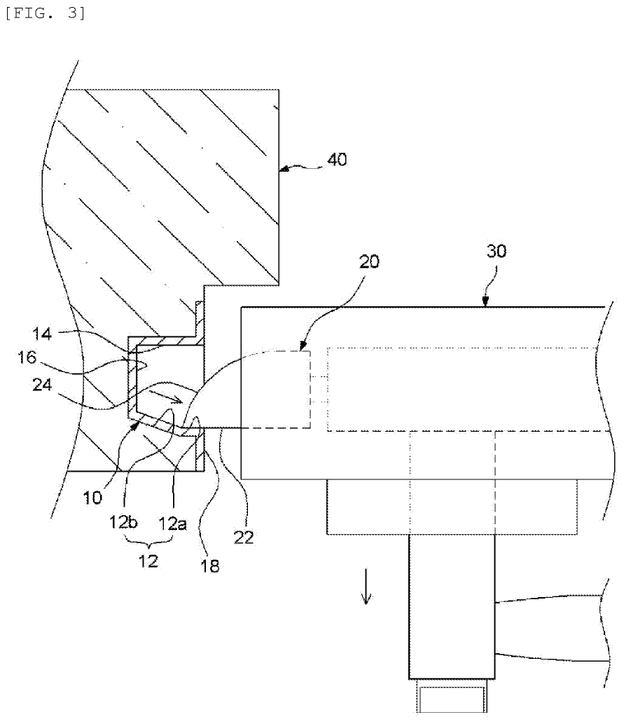

FIGS. 2 and 3 illustrate the door striker and a state wherein a latch is coupled to the door striker according to one embodiment of the present invention.

As shown in the figures, according to this embodiment, a latch assembly is mounted at a lateral surface of a door 30 and operatively connected to a handle member. Further, a striker 10, to which a latch 20 of the latch assembly is fitted and engaged, is mounted on a door frame 40. In this regard, the striker 10 includes a front sill 12 for latching a front surface 22 of the latch, as well as a rear sill 14 for latching a rear surface 24 of the latch, wherein the front sill 12 is composed of a right-angled surface 12a at a front end and an inner inclined surface 12b so that, when inserting the latch 20, an end 22a of the front surface 22 of the latch 20 contacts the inclined surface 12b by an elastic member (not shown) in the latch assembly while keeping the rear surface 24 of the latch 20 in contact with the rear sill 14 (see FIG. 2), and wherein, even when the door 30 is pushed to one side by external force and the front surface 22 of the latch 20 slides along the inclined surface 12b, the latch is caught by the right-angled surface 12a at the front end to thus prevent the door 30 from being opened (see FIG. 3).

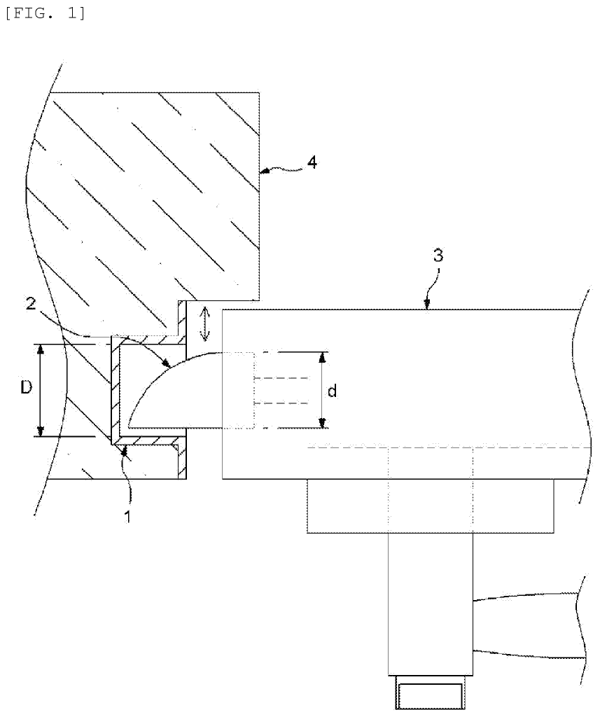

An angle of the inclined surface 12a of the front surface 12 should be designed in consideration of a thickness of the latch 20 (see reference numeral ‘d’ in FIG. 1) and a width in the front and rear sides of a groove in the striker 10 (see reference numeral ‘D’ in FIG. 1). Therefore, it is preferable to form an angle at which the end of the front surface 22 of the latch 20 may contact at any position of the inclined surface 12 while the latch 20 is completely protruded and, at the same time, the rear surface 24 of the latch 20 may be in continuous contact with a front end of the rear sill 14 in the striker 10.

Further, a border between the inclined surface 12b and the right-angled surface 12a may exist in a proper depth such that the latch 20 may maintain a state of being stably stuck to the door striker 10, and preferably, a length of about ⅓ the protruding length of the latch 20.

In the present embodiment, the latch 20 has the front surface 22 in a plane shape and the rear surface 24 in an arc shape, however, the present invention is not limited to the above embodiment and may of course be applied to any latch including front and rear surfaces 22 and 24 in a plane form.

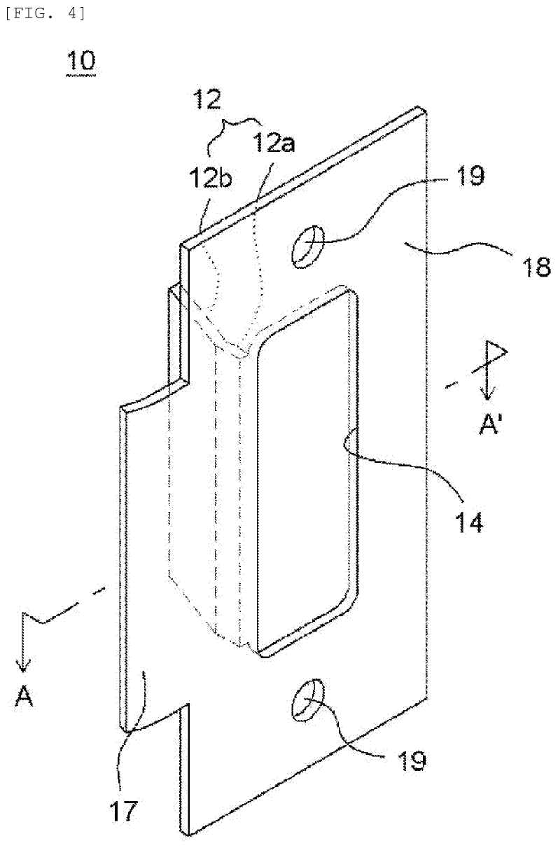

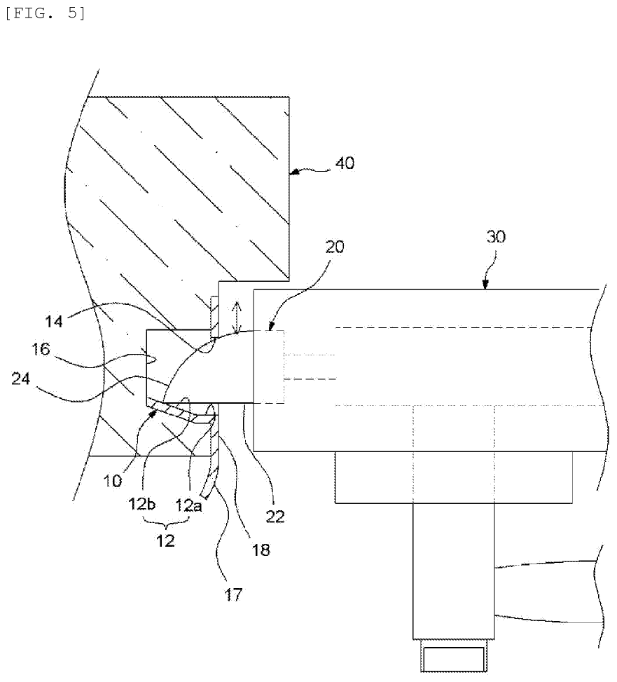

Further, in the present embodiment, the door striker 10 is represented as an injection-molded or cast product wherein the front sill 12 and the rear sill 14 for latching the latch 20 are integrated with an inner bottom surface 16. However, the present invention is not limited to the above embodiment and, as shown in FIGS. 4 and 5, may be applied to a press-worked door striker without a bottom surface (16; see FIGS. 2 and 3). Further, the door striker may be fabricated with two parts, that is, a plate member exposed to a front surface of the door frame and a groove member embedded inside the door frame, wherein the inclined surface 12b as well as the right-angled surface 12a (of the front sill 12) are disposed at one side of the groove member embedded inside the door frame, thereby attaining the same functions and effects as the striker according to the above embodiment or another embodiment described later. Still further, a groove member having such an inclined surface and a right-angled surface as described above may be put into the existing plate member, thereby exhibiting the same functions and effects as described above. Accordingly, it is obviously understood that such simple alterations or modifications are within the scope of the present invention described below.

FIGS. 4 and 5 illustrate a door striker, to which a latch is coupled, according to another embodiment of the present invention.

The door striker 10 according to the present embodiment is manufactured through press working, wherein a front sill 12 has a right-angled surface 12a and an inclined surface 12b while a rear sill 14 is in a perforated condition.

The door striker 10 according to the present embodiment is manufactured using an iron or stainless steel sheet material by a press working process, wherein thread holes 19 are formed on upper and lower portions of a front surface 18 in order to couple the striker to a door frame 40 using a fixing screw not shown in the figures, and wherein an inclined guide 17 is integrally provided at one side of the front surface 18 in order to prevent collision of a door 30 to a rear surface 24 of a latch 20 and, at the same time, to slightly press and guide the latch 20 to a groove in the striker.

As described above, the door striker according to the present invention is characterized in that: when inserting the latch, the latch protruded by the elastic member inside the latch assembly may be maintained to closely contact with the front and rear surfaces of the door striker, thereby preventing the door from rattling or shaking despite of wind or a change between indoor and outdoor air pressures.

Therefore, it is possible to keep a room quiet, eliminate an uneasy feeling due to rattling of the door and prevent the latch from being unfastened from the striker, thereby achieving advantages that completely ensure protection of privacy and enable the quality of the door.

### DESCRIPTION OF REFERENCE NUMERALS

10: Door striker
12: Front sill
12a: Right-angled surface
12b: Inclined surface
14: Rear sill
16: Bottom surface
17: Guide
18: Front surface
19: Thread hole
20: Latch
22: Front surface
24: Rear surface
30: Door
40: Door frame
d: Thickness of latch
D: Width in front and rear sides of striker

1. A door striker for preventing movement of a door, comprising:
a latch assembly provided on a lateral surface of a door and operatively connected to a handle member; and
a striker, to which a latch of the latch assembly is fitted, mounted on a door frame, wherein:
the striker has a front sill for latching a front surface of the latch and a rear sill for latching a rear surface of the latch, wherein
the front sill has a right-angled surface at a front end and an inner inclined surface so that, when inserting the latch, an end of the front surface of the latch contacts the inclined surface 12b via an elastic member in the latch assembly while keeping the rear surface of the latch in contact with the rear sill, and
even when the door is pushed to one side by an external force and the end of the front surface of the latch slides along the inclined surface, the latch is caught by the right-angled surface at the front end to thus prevent the door from being opened.
